(19) United States
(12) Patent Application Publication
(10) Pub. No.: US 2016/0259494 A1
(43) Pub. Date: Sep. 8, 2016

(54) SYSTEM AND METHOD FOR CONTROLLING VIDEO THUMBNAIL IMAGES

(71) Applicant: InfiniGraph, Inc., Menlo Park, CA (US)

(72) Inventors: Chase McMichael, Menlo Park, CA (US); Chris Murphy, Austin, TX (US)

(21) Appl. No.: 14/752,813

(22) Filed: Jun. 26, 2015

Related U.S. Application Data
(60) Provisional application No. 62/127,272, filed on Mar. 2, 2015.

(51) Int. Cl. G06F 3/0482; H04L 29/08

(52) U.S. Cl. CPC G06F 3/0482; H04L 67/02; H04L 67/22

(57) ABSTRACT

A system for controlling video thumbnail images, comprising an analytics engine that collects statistics related to user behavior regarding electronic media content, and a distribution engine that receives electronic media content and determines an optimal distribution of content to network-connected user devices, and a method for controlling video thumbnail images using the system of the invention.

### CROSS-REFERENCE TO RELATED APPLICATIONS

This application claims the benefit of, and priority to, U.S. provisional patent application Ser. No. 62/127,272, titled “SYSTEM AND METHOD FOR CONTROLLING VIDEO THUMBNAIL IMAGES”, filed on Mar. 2, 2015, the entire specification of which is incorporated herein by reference in its entirety.

### BACKGROUND OF THE INVENTION

1. Field of the Art

The disclosure relates to the field of electronic media, and more particularly to the field of selecting image thumbnails for use in video media content.

2. Discussion of the State of the Art

When presenting video content to a viewer such as via a webpage or media player application, it is common to display a static image thumbnail representing the video content (for example, an image taken from the video itself), generally to aid a viewer when selecting what media to view. Traditionally, these thumbnails must be manually selected by the video content provider (for example, the user that uploaded the video content to a web service, or the service provider that is hosting the media). Video hosting services such as YOUTUBE™ or FACEBOOK™ may prompt a user to select an image from a video during an upload, or automatically take a selection of static images from the video and present them to the content uploader to choose from, or they may prompt the user to select and upload an image of their own choosing when uploading video content.

A variety of image processing algorithms and methods are available in the art and may be used to identify video attributes such as color, lighting, clarity, sharpness, or other metadata. These attributes may then be used to select ideal image preview thumbnails for the video, generally those images that are most likely to result in a viewer selecting the video or watching it to completion. These recommendations may then be presented to the video uploader as choices to select for their video thumbnail.

There has been a focus on optimizing these static image thumbnails to increase viewer click rates or other metrics, but the emphasis is currently on identifying the most likely image according to attributes of the video itself, without regard for actual human activities such as a viewer's social network activities or interests, or what they may be currently searching for when a particular video is presented to them for selection (it may be that they aren't interested in the content of a video that was included in a search result listing). Additionally, there are no efforts being made to utilize non-static or variable image thumbnails, that may be changed to adapt to a particular viewer to increase likelihood of a video being viewed.

What is needed, is a means to select and present an image thumbnail for a video based on a user's actions or interests, and a learning system that can control the presentation of image thumbnails to continually change or adapt them according to viewers and their activities, to further optimize viewer statistics beyond what is possible by simply identifying characteristics of the video itself when choosing an appropriate thumbnail preview image.

### SUMMARY OF THE INVENTION

Accordingly, the inventor has conceived and reduced to practice, in a preferred embodiment of the invention, a system and method for controlling video thumbnail images.

According to a preferred embodiment of the invention, a system for controlling video thumbnail images, comprising an analytics engine comprising at least a plurality of programming instructions stored in a memory operating on a network-connected computing device and adapted to collect at least a plurality of statistics related to at least a user behavior regarding a plurality of electronic media content, the media content comprising at least a video clip; and a distribution engine comprising at least a plurality of programming instructions stored in a memory operating on a network-connected computing device and adapted to receive at least a plurality of electronic media content and determine an optimal distribution of content to a plurality of network-connected user devices, is disclosed.

According to another preferred embodiment of the invention, a method for controlling video thumbnail images, comprising the steps of: receiving, at a distribution engine, a plurality of video media content; processing at least a portion of the media content; producing a plurality of still images based at least in part on at least a portion of the processing results; processing at least a portion of the plurality of static images; presenting at least a portion of the static images to a user; and tracking user behavior based at least in part on at least a portion of the presented static images, is disclosed.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is another block diagram illustrating an exemplary hardware architecture of a computing device used in various embodiments of the invention.

FIG. 5 illustrates an exemplary computer system that utilizes machine learning to select thumbnails according to an embodiment of the invention.

FIG. 6 is an illustration of an exemplary frame selection process for selecting a portion of frames from a video clip for segmenting, according to an embodiment of the invention.

FIG. 7 is a flowchart illustrating an exemplary method for ranking a plurality of thumbnails over a target network, according to an embodiment of the invention.

FIG. 8 is an illustration of an exemplary operation for selecting high-ranking thumbnails, according to an embodiment of the invention.

FIG. 9 is an illustration of an exemplary user interface for thumbnail processing, according to an embodiment of the invention.

### DETAILED DESCRIPTION

The inventor has conceived, and reduced to practice, in a preferred embodiment of the invention, a system and method for controlling video thumbnail images.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

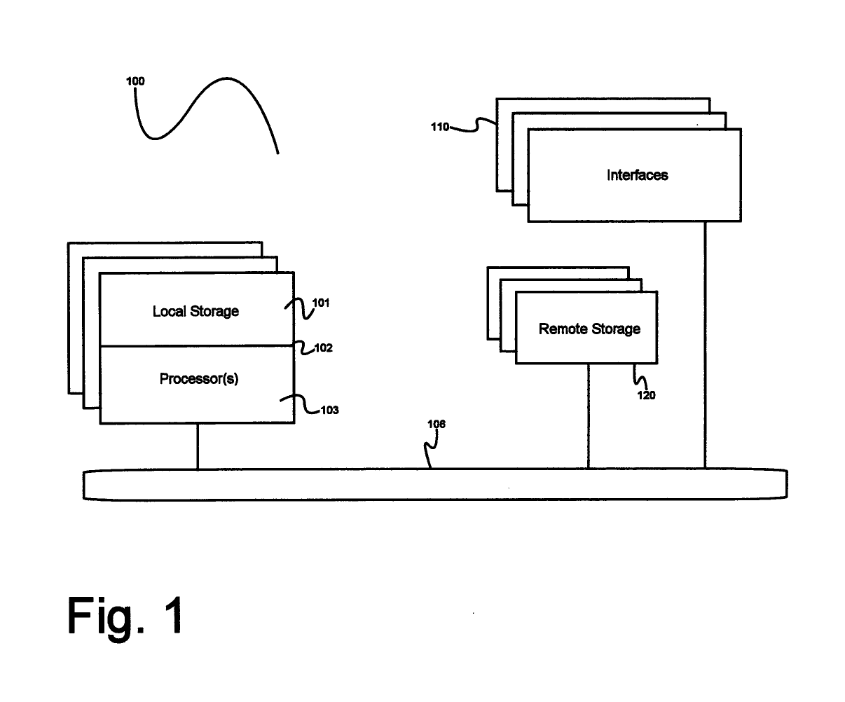

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

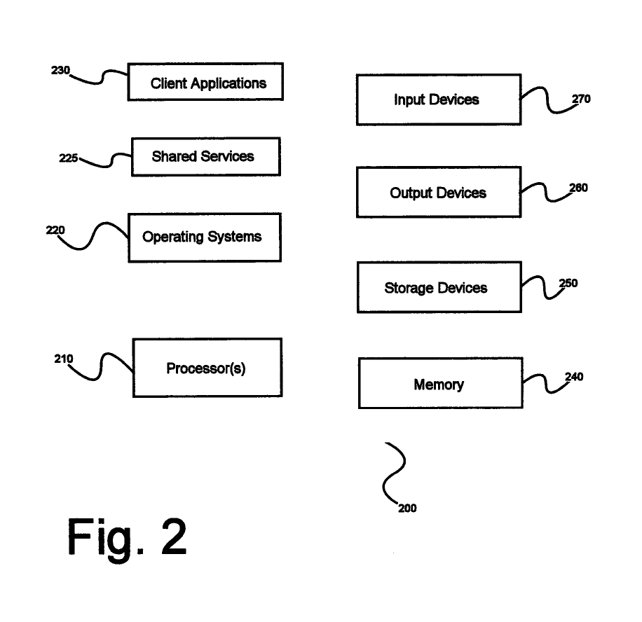

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 225 may be operable in system 200, and may be useful for providing common services to client applications 230. Services 225 may for example be WINDOWS™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

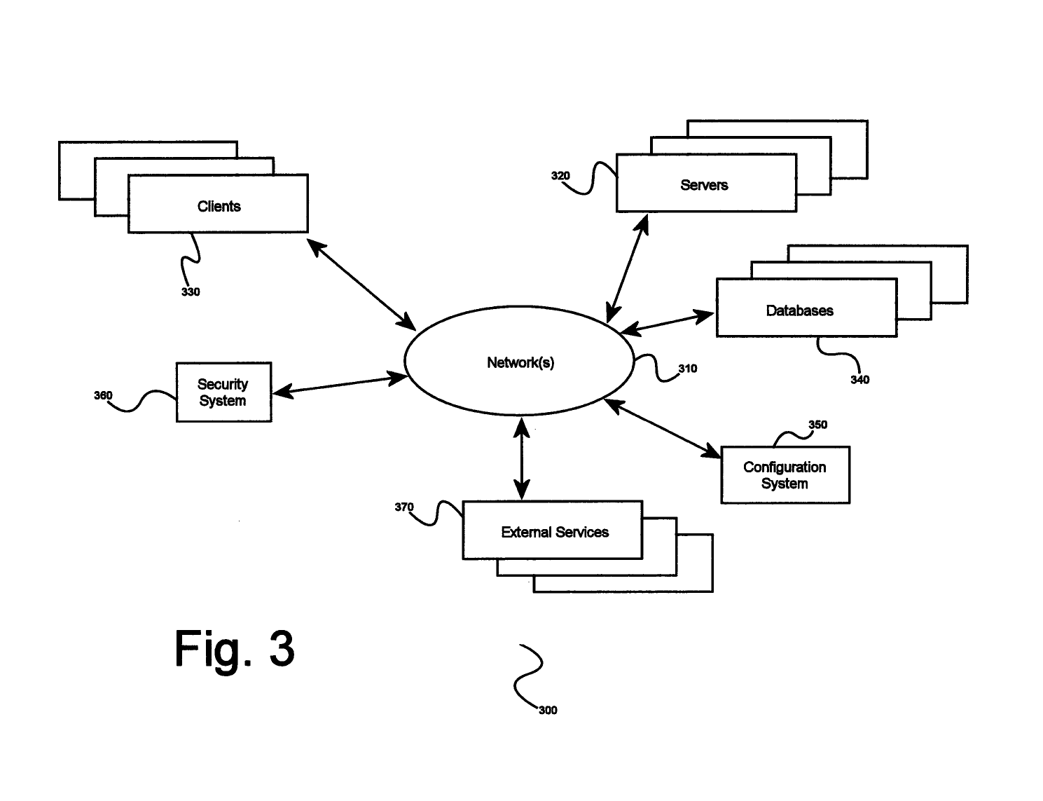

In some embodiments, systems of the present invention may be implemented on a distributed computing network, such as one having any number of clients and/or servers. Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as WiFi, Wimax, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

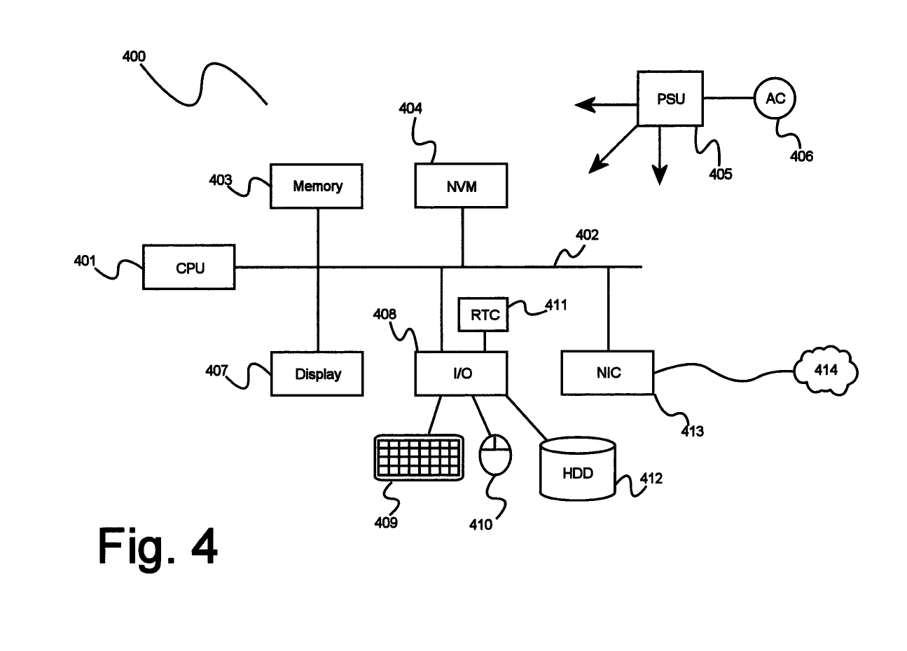

FIG. 4 shows an exemplary overview of a computer system 400 as may be used in any of the various locations throughout the system. It is exemplary of any computer that may execute code to process data. Various modifications and changes may be made to computer system 400 without departing from the broader scope of the system and method disclosed herein. CPU 401 is connected to bus 402, to which bus is also connected memory 403, nonvolatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to ac supply 406. Not shown are batteries that could be present, and many other devices and modifications that are well known but are not applicable to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

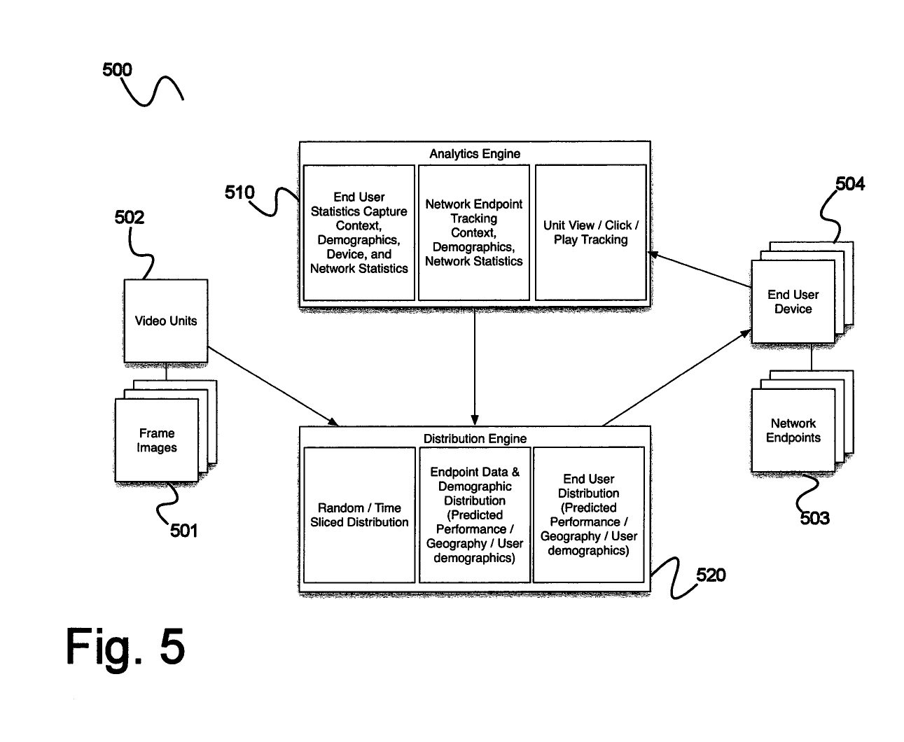

FIG. 5 illustrates an exemplary computer system 500 that utilizes machine learning to select thumbnails according to an embodiment of the invention. According to the embodiment, a plurality of image frames 501 comprising still imagery may be associated with a plurality of video portions 502 that may comprise segments or clips of video-based media content. Associated groupings of video and image content may be processed by a distribution engine 520 that may comprise at least a plurality of programming instructions stored in a memory and adapted to receive media content and determine an optimal distribution of content to end user devices 504 or network endpoints 503 that may be considered endpoints of a media content network (that is, network-connected devices that may receive media content or other network communication), where media may be presented for viewing but is no longer processed or changed. In this manner, network endpoints may be considered devices for content consumption, whereas content modification or creation functions are performed elsewhere according to the embodiment). Distribution engine 520 may perform functions such as selecting content for presentation to users based on known demographic or analytics information, such information being collected and provided by an analytics engine 510 that may comprise at least a plurality of programming instructions stored in a memory and adapted to collect statistics, demographic information, network statistics, device information, behavior tracking information, or other such measureable or quantifiable information that may be relevant to user devices 504, network endpoints 503, or user behaviors while interacting with a network (such as, for example, what media a user views or other behavior tracking information). For example, an analytics engine may track user behavior through device-based or software-based means, such as location or hardware device monitoring or browser “cookies” that may track a user's web browsing behavior or preferences.

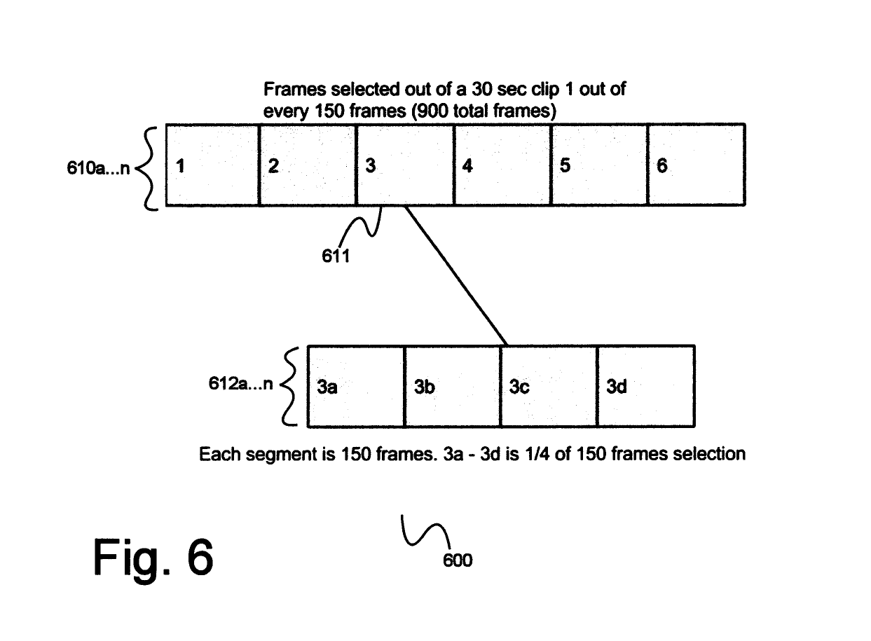

FIG. 6 is an illustration of an exemplary frame selection process 600 for selecting a portion of frames from a video clip for segmenting, according to an embodiment of the invention. According to the embodiment, a video clip may comprise a plurality of still image frames 610a-n, for example a 30-second clip comprising 900 still image frames as illustrated. Still frames 610a-n may be grouped or segmented into divided portions, for example a quantity of 900 frames may be grouped into 6 equal segments comprising 150 frames each. It should be appreciated that while a specific segmenting arrangement is illustrated for clarity, such an arrangement is intended to be exemplary and segments need not necessarily be equal in distribution, for example unequal segments of 600, 200, 75, and 25 still frames each might be utilized when segmenting a quantity of 900 frames, and it should be further appreciated that any other such arrangement or distribution may be utilized according to the embodiment. A particular segment 611 may be further divided into smaller segments 612a-n, for example a group of four smaller segments “3a” through “3d” may each comprise approximately ¼ of a selected video segment as shown. Again, it should be appreciated that while an equal distribution of frames into smaller segments 612a-n is shown, such an arrangement is exemplary and alternate arrangements or distributions of frames may be utilized according to the embodiment. In this manner, arbitrary video portions may be selected and divided into discrete segments or still frames for use according to the invention.

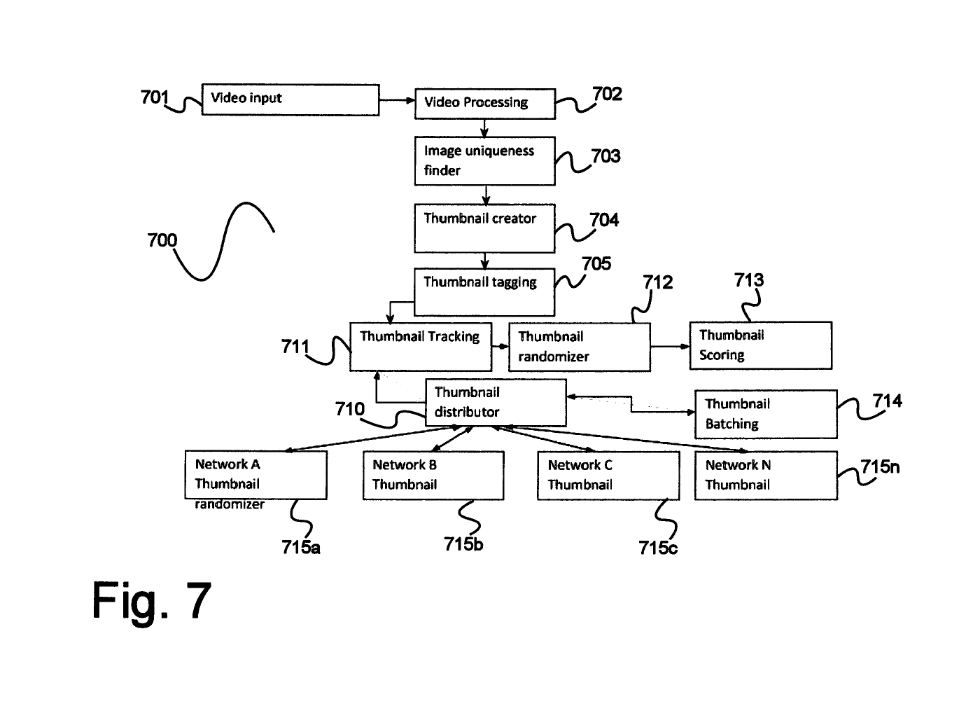

FIG. 7 is a flowchart illustrating an exemplary method 700 for ranking a plurality of thumbnails over a target network, according to an embodiment of the invention. According to the embodiment, a video input 701 may comprise a portion of video-based media content, and may be processed in an initial processing step 702, such as by a distribution engine (as described previously, referring to FIG. 5). Video processing may produce a plurality of static images for use as thumbnails, and static images may then be processed according to an image uniqueness finder 703 operated by a distribution engine, for example to identify image frames that are sufficiently distinct from known thumbnails in use, for example to provide users with an easy way to identify a specific video from a plural video listing (such as a search results page presenting a number of videos to a user). Image frames may then be processed by a thumbnail creator 704 to produce static thumbnails appropriate for use (for example by cropping, rotating, or color-correcting the image frames to ensure a quality thumbnail is selected for use), and in a next processing step 705 thumbnails may then be processed and “tagged” with metadata to identify specific attributes (such as aspect ratio, color depth, or other image technical properties) or content features (such as identifying specific persons or places present in an image). Thumbnails may then be identified and tracked in an initial distribution step 711 that may be performed by a thumbnail distributor 710 computer, such that (for example) specific thumbnails may be monitored to determine user behavior in response to selected tags or other attributes (for example to determine how effective a thumbnail selection was compared to historical or alternate thumbnails). In a further distribution step 712, thumbnails may be randomized such as for testing purposes, for example to publish a variety of alternate thumbnails and monitor results such as video viewership or user interaction, and results may then be used in a thumbnail scoring step 713 to identify more effective thumbnails, thumbnail attributes, or metadata for future reference. A thumbnail distributor 710 may also “batch” or group thumbnails for ease of storage, reference, or use in a batching step 714, for example by categorizing thumbnails by their metadata or other characteristics, or by grouping thumbnails by their scores as determined in a previous scoring step 713. Finally, a thumbnail distributor 710 may present selected thumbnails for use in media networks 715a-n, such as for inclusion as preview images for hosted video content or for presentation in search results or other similar placeholder functions where a thumbnail may be used to represent an associated video.

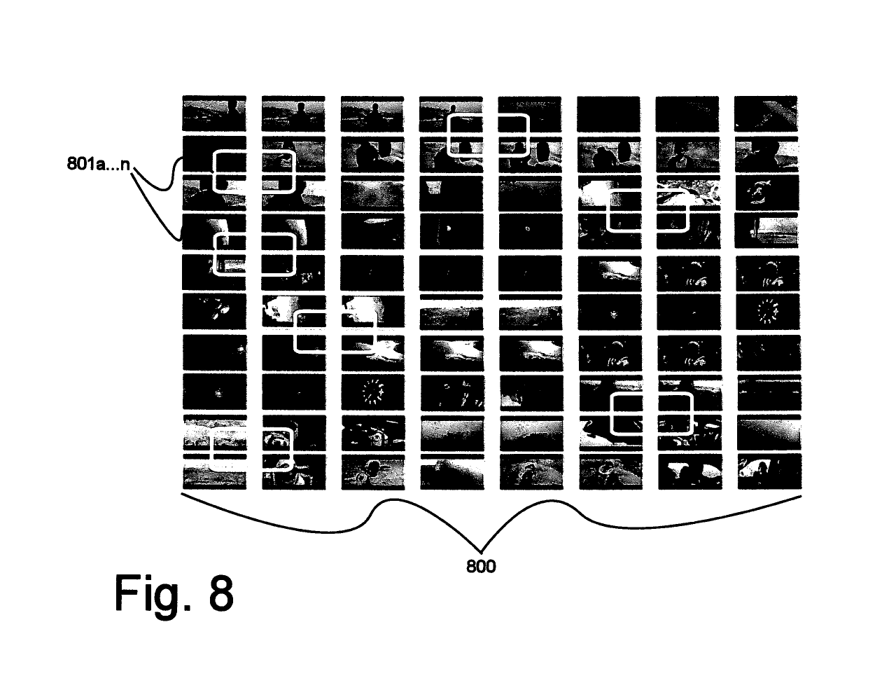

FIG. 8 is an illustration of an exemplary operation for selecting high-ranking thumbnails, according to an embodiment of the invention. According to the embodiment, a plurality of video content thumbnails 800 such as those used by video clips or user recordings, may be analyzed to determine their usefulness or relevancy, for example by analyzing user behavior statistics or other tracked metrics to indicate the results of a particular thumbnail choice (as described above, with reference to FIG. 7). An analysis server may identify thumbnails groups 801a-n that “batch” or categorize thumbnails based on their scoring or similar characteristics, for example such as grouping together “the top four thumbnails incorporating views of the ocean”. In this manner, thumbnails may be tracked and scored according to their effects on user behavior and video viewership, and this scoring may be used to identify high and low performers within a set of thumbnails. These groupings may then be used in machine learning or manual configuration to optimize video thumbnails to achieve desired results, such as described previously (referring to FIG. 6), wherein a user is presented with high-performing thumbnails or video content portions in order to optimize their content.

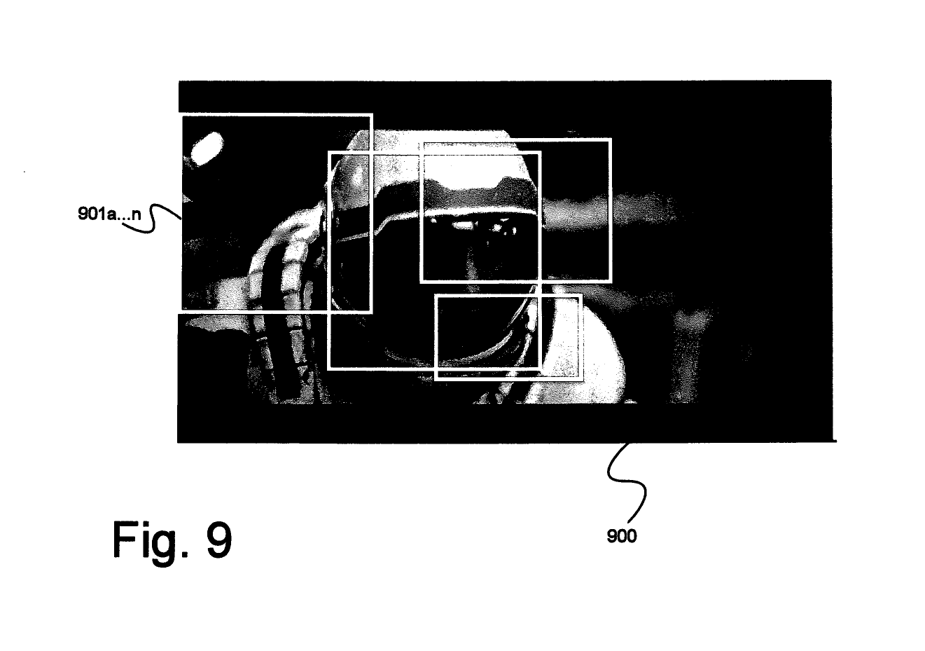

FIG. 9 is an illustration of an exemplary user interface 900 for thumbnail processing, according to an embodiment of the invention. According to the embodiment, a graphical user interface 900 may be presented to a user for managing their media content, for example to select an image thumbnail for use in previewing a video they are uploading, or to change an image thumbnail on a currently-hosted video. According to the embodiment, a user may be presented with visually-indicated regions 901a-n indicating portions of a video frame that may be more likely to promote viewing or other user behaviors, or to indicate regions of an existing video that users have shown an interest in (such as regions that have been “clicked” by viewers, or have received user-submitted comments or annotations, as are common in various video content hosting services). In this manner, a user may be provided with the means to optimize their video and thumbnails to generate user behavior or traffic, and they may be provided with a simple and easily understood interface for reviewing behavior patterns or other monitored statistics related to their content, so they may make more informed and effective decisions regarding the configuration of their video and thumbnail content.

### DETAILED DESCRIPTION OF EXEMPLARY EMBODIMENTS

### Video Image Extraction Process

According to a preferred embodiment, a plurality of high quality image frames may be extracted from a video (whether streaming over the Internet or stored in a file), and a combination of algorithms may be used to reduce the size or number of similar images while maintaining the quality of the images provided for distribution. Reducing similar images may be done via a multi-pass process utilizing both common and novel image processing techniques. For similar image comparison an algorithm known as “mean squares error” (MSE) that takes a color difference of each pixel, squares it, then calculates the average of the squared differences, may be used. A novel hashing mechanism known as dHash may then be used. dHash has proven to be more accurate than previous hashing algorithms known in the art (e.g., aHash and pHash), particularly when determining similarity of images. According to a preferred embodiment of the dHash algorithm, a hash is generated by reducing image size and color of an image, then generating a difference between adjacent pixels. Once that process is complete, each pixel in the image is assigned a bit in the hash based on the “brightness” compared to its adjacent pixel. This gives a calculated hash that can be used to further reduce similar or duplicate images. These hashes may be utilized in long-term analytics as well.

According to another embodiment, an initial sequence of thumbnails may be generated according to a random or pseudorandom number generator or algorithm. Each thumbnail may be labeled and selected by a random number generator over a number of unique videos views. Generally, random number generators generate a sequence of integers by the following recurrence:

x₀=given, xₙ₊₁=P₁xₙ+P₂ (mod N) n=0, 1, 2, (*)

It can be appreciated that the quantity of unique segmented thumbnails must be greater than 1, as any video clip must (by the very nature of being video and not a still image) contain at least two still frames (which may then be separated into two distinct thumbnail images). Changes in visual attributes within a video are required to create unique segmentation when producing thumbnails. Viewership or participation metrics may be used to quantify the volume of unique persons seeing a thumbnail, and may be used to directly adjust the frequency of a random selection, as fewer thumbnails may be shown over time due to learning a user behavior pattern on a target network. The larger the viewable audience is, the faster and more accurate the sequence selection occurs due to having a larger sample group and therefor a greater pool of available data from which to draw.

According to another embodiment, an initial collection of thumbnails may be reduced to a smaller set, for example to facilitate processing of large collections of thumbnails for long videos. A collection may be initially based on unique set of segments. A second collection may be reduced, for example based on a variable X, wherein X is the number of plays (or other such user interaction or quantifiable behavior) in a specific interval (such as a time-based or threshold-based interval as described below, for example “per 1000 pages viewed”). Variables used in reduction (such as X according to the example described previously) may be at least partially determined by network size and frequency of user engagement with a specific video, thereby quantifying network and user statistics for easy use in algorithmic processing. Engagement may be measured using a variety of available metrics, such as number of times a user selects or views a video (“clicks”), number of times or length of time spent looking at a thumbnail or preview for a video (such as a computer mouse pointer hovering over the video), sharing via social media (posting links to a video in blog posts or via TWITTER™, sharing a video on FACEBOOK™ or other similar means of sharing content or making it known what content a user is viewing or considering), or comments on a video or a video hosting service. As more thumbnails achieve a higher X value a natural selection process occurs providing for a learning method on what thumbnails perform the highest over that target network end point.

Threshold-based intervals may be based on number of videos, clicks, plays, “mouseovers”, “likes”, social media shares or any other suitable measure of user behavior or engagement, and may be quantified and used to determine when a reduction to a smaller set of selected thumbnails will occur. Once a minimum “threshold” value is reached, a thumbnail collection may be reduced by a predetermined, configurable, or dynamic (that is, determined during operation in response to known metrics such as, for example, to what degree a threshold was exceeded) quantity or portion. Then, a random display process of thumbnails may continue or iterate, utilizing the reduced set. The reduction process may continue until a quantity of top performing thumbnails (effectively the “ideal” thumbnails as determined by previously-described machine learning) are determined.

It can be appreciated that a person's screen properties may affect the quantity or quality of visual information presented to them. For example, a user on a smartphone (which necessarily has a small physical screen size) may be able to see or process a smaller quantity of visual information than a user viewing content on a high-definition television. Various display properties that may affect visual information in this manner may be physical screen size, screen resolution (that is, how many pixels a screen contains along each axis, for example the common

“Full HD” nomenclature used in a television or film context is measured as 1920 pixels horizontally and 1080 pixels vertically, or in a computing context may be referred to as “1920×1080” or “1080p”, meaning 1080 lines of progressively-scanned pixels), pixel density (that is, how many pixels are displayed within a given physical area, commonly measured in pixels per inch and calculated from a display's resolution and physical dimensions), color gamut (the range or intensity of colors a display is capable of representing), brightness, viewing angles, or any other such physical or electronic display properties. Thumbnails may be presented in different sizes or with different properties (such as with a specifically configured color range or aspect ratio) on different network end points, altering the visual presentation on each end point generally to attempt to maximize user engagement by taking into consideration the capabilities or properties of their particular device. This may greatly affect the amount of information that is passed to a human viewer, causing different reactions to visual imagery depending on the properties of the display and uniqueness of the objects presented within an image via the display.

These methods of selecting an ideal thumbnail—taking into consideration the properties of a device or a display, utilizing network statistics, location (region) information, and based on user behavior may be very different. The need for a means to dynamically display thumbnails based on the above parameters generally means thumbnail management must be optimized according to user behavior or engagement on a per-network basis. This quantifiable “human factor” is unique and may be used to create a behavioral scoring method whereby a thumbnail within a video creates the greatest number of plays based on network, domain or other endpoint variables—thereby quantifying user behavior and using that quantified value to ultimately arrive at an ideal thumbnail as described previously.

In an exemplary use case, a one-second portion of video may contain 30 still images (referred to as 30 frames per second, a common video frame rate). Each frame in the exemplary video may have the potential to be the “most appealing” to a specific market segment or region on a given target device. The “appeal” of each frame may be quantified according to user interactions such as video plays (the number of times a user or market segment views the video), the number of plays within a given time frame, plays from a specific network on which the video is being hosted or presented, within an app such as a game or native advertising to a particular device such as a user's phone, or part of published content supporting video. In this manner it may be appreciated that a wide variety of metrics may be monitored for use in determining which thumbnail may be ideal for a given video segment, and in what context the selected thumbnail may be ideal. For example, a thumbnail that appeals to one market segment may not have the same appeal to another market segment (such as appealing to specific demographic groups), or appeal on one network may not be reflected on other networks.

Displaying thumbnails over time or based on volume of measured plays may be used to determine thumbnails with high appeal (“high performers”), and enables real time A/B testing on each network end point. Dynamically updated thumbnails may be used to continually optimize results, by updating a selected thumbnail based on the most recent appeal metrics so that thumbnails may always be relevant with regard to their recent or current viewers.

Selection of thumbnails may be based on a random or pseudorandom order, and segmenting video thumbnails according to specific intervals (such as, for example, segmenting every 3 frames or every 0.5 second) may be used to reduce the number of overall thumbnails available. Machine learning may thereby quantify viewer interaction and scoring linked to each thumbnail, producing an “image context preference” per network that may correspond to a particular image's appeal to a particular network. “Context” may be considered a thumbnail image's visual content, that is “what objects are in the image that make the thumbnail unique”. The “content” may be still images captured from video. Viewer behavior may be measured to produce the most useful results (that is, results that may be considered highly relevant or useful as they are directly based on actual observed human behavior patterns rather than simulations or predictions) and a thumbnail selection may change over time according to varying preference within a network, such as according to behavior of new viewers, or to reflect gradually changing preferences over time within a group of viewers on a network, or due to “visual fatigue”—a phenomenon referring to a tendency to change preference after growing tired of similar visual imagery after a time (effectively, a viewer's urge to “see something new”, even if the current imagery suits their preferences). To combat visual fatigue, a thumbnail may be updated and compared to past performance, for example to known appeal statistics for lower-performing thumbnails within a grouping.

According to another embodiment, a set of thumbnails may be combined into an animated sequence of images to make an animated thumbnail, such as a short video clip representative of a longer video, or a brief animated image as is common in computer usage.

### Real-Time Distribution of Video Advertisement

Utilizing images from an image extraction process, an “advertising unit” may be created that dynamically displays one or more of the images for a video based on a variety of factors such as user engagement or network statistics.

The advertisement may be in a continual real-time “test and reduce” cycle, wherein an image is chosen to be displayed based on a variety of variables (generally in real-time) at the time the advertisement is viewed. A variety of different machine learning and statistical analysis techniques may be utilized to make real-time decisions such as to determine which image will be displayed to a user viewing an advertisement. Several exemplary factors that may be taken into account when determining images to display are described below.

According to an embodiment, time-based testing and random distribution based on volume may be utilized. At the beginning of distribution an image will use a quantified “views” metric to continually update an information model used to determine image distribution. Over the length of distribution, images may be randomly selected and delivered for a time period based on the overall volume of views. Based on the volume and time factors involved, this test and reduce cycle may continue until a “success” threshold is determined for any available metrics. As data is collected the system may auto-adjust and determine higher-performing images based on several factors, either historical or real-time.

According to another embodiment, historical image statistics may be utilized to keep track of image statistics and determine historical interaction levels of “similar” images, across multiple networks or campaigns, and utilize the results to make predictive decisions.

According to another embodiment, historical network endpoint and property statistics may keep statistics on sites and distribution networks that have been utilized in the past and decisions may be based on what has worked on those various properties in the past.

According to another embodiment, high-level demographics may be used to process various demographic information about a broader user base when making decisions. Geography, device type, and network or property demographics are some exemplary demographic metrics that may be utilized, and it should be appreciated that a variety of additional or alternate metrics may be utilized according to the embodiment.

According to another embodiment, individual profile information may utilize historical data at an individual viewer level. Information utilized may have been obtained both historically and during a distribution. Real-time data, such as whether the user has seen the image already or viewed the advertisement on another property, may be used. When available, social connections and other historical profile information as well as geography, gender, and associated social network data may be utilized in the model.

According to another embodiment, cookies (a browser tracking method) may be utilized to ensure that a thumbnail in a sequence is not being seen repetitively and to maximize exposure to available thumbnails in a sequence. A viewer may see unique thumbnails as they move to other content, thereby combating “visual fatigue” as described above, on a per-person basis.

Consumers may move from site to site (such as navigating between webpages, or switching applications on a computing device) and re-targeting may be used via cookies on a mobile or desktop browser or web-enabled application (such as an application that operates a web browser as a portion of its functionality). For other applications, different targeting methods may be used such as a login session key, or a hash going through ad exchanges. In this manner a promoted video would not contain the same thumbnail but the same video would be displayed repeatedly to the same viewer regardless of their current device, location, network, or other variables.

According to another embodiment, a frame selection may be expanded such that a high-performing area increases the probability of higher play rates overall on other networks. A selection of initial thumbnails may be segmented and can be dynamically reduced intelligently based on knowledge that one sequence of the video produces higher play rates over other areas.

According to another embodiment, a set of thumbnails can perform on various days and a set of thumbnails may alternate based on daily performance. For example, one thumbnail may have higher performance on weekends or on a particular day of the week, while having reduced performance at other times.

A self-optimizing algorithm may be able to detect consumer actions in each segment to determine the top level segments yielding the highest play rates. This may be considered a clear indication that a segment in the clip is most interesting in still format (that is, it may produce the highest-performing thumbnails based on the performance observations for the clip itself), and processing may shift to other thumbnails in the sequence.

It may be appreciated that regional and content site dependencies may play an important role in play rates. According to an embodiment, a system may provide the ability to serve thumbnails to different market segments, creating a personalization according to a user's location and other factors that may not require a particular thumbnail (that is, such determinations may be made prior to a thumbnail selection and scoring process). Processing may continue iteratively and adapt over time as images “age” or their performance statistics change, or as viewers become visually fatigued.

The skilled person will be aware of a range of possible modifications of the various embodiments described above. Accordingly, the present invention is defined by the claims and their equivalents.

What is claimed is:

1. A system for controlling video thumbnail images, comprising:
an analytics engine comprising at least a plurality of programming instructions stored in a memory operating on a network-connected computing device and adapted to collect at least a plurality of statistics related to at least a user behavior regarding a plurality of electronic media content, the media content comprising at least a video clip; and
a distribution engine comprising at least a plurality of programming instructions stored in a memory operating on a network-connected computing device and adapted to receive at least a plurality of electronic media content and determine an optimal distribution of content to a plurality of network-connected user devices.

2. The system of claim 1, wherein the collected statistics comprise at least a user device's hardware capabilities.

3. The system of claim 1, wherein the collected statistics comprise at least a user's browsing behavior.

4. The system of claim 1, wherein the collected statistics comprise at least a plurality of network statistics.

5. The system of claim 1, wherein the distribution engine selects media for presentation to a user device based at least in part on at least a portion of statistics collected by an analytics engine.

6. A method for controlling video thumbnail images, comprising the steps of:
receiving, at a distribution engine, a plurality of video media content;
processing at least a portion of the media content;
producing a plurality of still images based at least in part on at least a portion of the processing results;
processing at least a portion of the plurality of static images;
presenting at least a portion of the static images to a user; and
tracking user behavior based at least in part on at least a portion of the presented static images.

7. The method of claim 6, further comprising the step of tagging at least a portion of the plurality of still images with a plurality of metadata information tags.

8. The method of claim 6, further comprising the step of determining at least a uniqueness measure for at least a portion of the plurality of still images.
